(19) United States
(12) Patent Application Publication
(10) Pub. No.: US 2015/0317642 A1
(43) Pub. Date: Nov. 5, 2015

(54) PROCESS TO QUERY ELECTRONIC SALES RECEIPTS WITH A PORTABLE COMPUTERIZED DEVICE

(71) Applicant: Wal-Mart Stores, Inc., Bentonville, AR (US)

(72) Inventors: Stuart Argue, Palo Alto, CA (US); Anthony Emile Marcar, San Francisco, CA (US)

(73) Assignee: Wal-Mart Stores, Inc., Bentonville, AR (US)

(21) Appl. No.: 14/266,256

(22) Filed: Apr. 30, 2014

(51) Int. Cl. G06Q 30/00; G06Q 20/04; G06K 19/06

(52) U.S. Cl. CPC G06Q 30/018; G06K 19/06112; G06Q 20/0453

(57) ABSTRACT

A process permitting a customer to access a stored electronic sales receipt and provide information from the electronic sales receipt to a customer service associate can include, in a computerized device operated by the customer, accessing the stored electronic sales receipt and generating a displayed indication to the electronic sales receipt. The process can further include, in a computerized device operated by the customer service associate, receiving the displayed indication and processing a transaction related to the electronic sales receipt based upon the displayed indication.

### BACKGROUND INFORMATION

1. Field of the Disclosure

The present disclosure relates generally to systems and processes for providing an electronic sales receipt for products purchased in a retail store. In particular, examples of the present disclosure are related to enabling a customer to provide an image upon a screen of a portable computerized device to provide a direct link to a stored electronic receipt.

2. Background

Consumers buy grocery products from a retail store for personal or family consumption. For a particular order, a customer selects items for purchase, the items are inventoried, for example by a sales clerk at a checkout register or by the customer at a self-scan station, and the customer provides payment for the inventoried order. A sales receipt is generated based upon the order and the payment, providing proof of purchase for the customer of the inventoried items. According to one embodiment, a sales receipt can be a printed paper ticket. Such a paper ticket receipt can include a barcode symbol, a QR code or three dimensional barcode, or other computer recognizable symbol enabling a store employee to scan the receipt an access a corresponding receipt or purchase history for the customer in a remote database. As part of an exemplary process to return a purchased good to the store, the store employee can scan the paper ticket receipt, scan the tem being returned, and a remote computerized server can match the scanned item to an item inventoried on the paper ticket receipt, and process the return. In this embodiment, the paper ticket receipt acts as a certification to the store that this customer in fact bought this item and has the right to return the item, for example, including a check of the date that the item was purchased and confirming that the intended return of the item is within store policies for time limits on returns.

Stores can monitor and record a purchase history for a customer, for example, as tied to a particular credit card number. In another embodiment, a purchase history or other information can be stored in combination with a membership number, a customer phone number, or any other identifying information for a particular customer or family. A series of electronic sales receipts can be recorded and stored for a particular customer providing details regarding each of a series of orders that the customer purchased at the store or at stores within a chain of stores.

### BRIEF DESCRIPTION OF THE DRAWINGS

Non-limiting and non-exhaustive embodiments of the present disclosure are described with reference to the following figures, wherein like reference numerals refer to like parts throughout the various views unless otherwise specified.

FIGS. 1A-1E are schematics illustrating a portable computerized device displaying a graphical user interface in communication with a customer service server, in accordance with some embodiments of the present disclosure;

FIG. 1A illustrates a plurality of electronic sales receipts provided to a customer for review and selection;

FIG. 1B illustrates an exemplary barcode associated with a selected electronic sales receipt displayed upon the portable computerized device;

FIG. 1C illustrates an alternative barcode associated with a selected electronic sales receipt displayed upon the portable computerized device; and

FIG. 1D illustrates a segment of a barcode number associated with a selected electronic sales receipt displayed upon the portable computerized device;

FIG. 1E illustrates a personal identification number associated with a selected electronic sales receipt displayed upon the portable computerized device;

FIG. 2 is a schematic illustrating components of an exemplary portable computerized device configured to access an electronic sales receipt, in accordance with some embodiments of the present disclosure;

FIG. 3 is a schematic illustrating components of an exemplary customer service server, in accordance with some embodiments of the present disclosure; and

FIG. 4 is a flow chart illustrating an exemplary process 200 for using electronic sales receipts based upon a customer query entered through a portable computerized device, in accordance with some embodiments of the present disclosure.

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present disclosure. Also, common but well-understood elements that are useful or necessary in a commercially feasible embodiment are often not depicted in order to facilitate a less obstructed view of these various embodiments of the present disclosure.

### DETAILED DESCRIPTION

In the following description, numerous specific details are set forth in order to provide a thorough understanding of the present disclosure. It will be apparent, however, to one having ordinary skill in the art that the specific detail need not be employed to practice the present disclosure. In other instances, well-known materials or processes have not been described in detail in order to avoid obscuring the present disclosure.

References throughout this specification to “one embodiment”, “an embodiment”, “one example” or “an example” means that a particular feature, structure or characteristic described in connection with the embodiment or example is included in at least one embodiment of the present disclosure. Thus, appearances of the phrases “in one embodiment”, “in an embodiment”, “one example” or “an example” in various places throughout this specification are not necessarily all referring to the same embodiment or example. Furthermore, the particular features, structures or characteristics may be combined in any suitable combinations and/or sub-combinations in one or more embodiments or examples. In addition, it is appreciated that the figures provided herewith are for explanation purposes to persons ordinarily skilled in the art and that the drawings are not necessarily drawn to scale.

Some consumers utilize capabilities of their portable computerized devices to prepare shopping lists or perform other tasks while shopping in a retail store. Use of such a portable computerized device can be enabled by communication between the device and remote computerized server, for example, maintained by the retail store or a chain of retail stores. A customer can, for example, operate shopping lists or other tasks, with information being shared between the portable computerized device and the server based upon a known identity of the shopper. An identity of the shopper associated with a particular device can be established by processes known in the art. For example, when a shopper enters a store or activates a computer program upon the portable computerized device, the shopper can supply a login account name and password associated with an established account. In another embodiment, biometric information such as a finger swipe or thumb print image identifiable by processes known in the art can be used to establish an identity of the shopper. In another embodiment, credit card information can be used to establish an identity of a shopper. Based upon an established identification of the shopper, the server can supply customer specific information to the portable computerized device to facilitate shopping and tasks associated with shopping.

Customers buy items at a retail store, and, for various reasons, decide to either return an item to the store for a refund or ask a customer service representative for assistance regarding a particular item. A store can require that a customer provide a receipt in order to provide a refund, an exchange, or perform other tasks related to a purchased item. Such a requirement prevents erroneous or fraudulent returns to a store, and provides information such as the date of purchase for review in combination with store return policies, return deadlines, warranty expirations, etc. A customer can lose or misplace a receipt. A process to provide a customer with convenient access to sales receipts can include associating purchases of a shopper with an identity of the shopper, storing electronic receipts for historical purchases, and providing the shopper with access to the stored electronic receipts upon demand.

When a customer provides a paper ticket receipt to a customer service associate at a retail store, the associate can in one embodiment scan a barcode printed upon the receipt. Based upon the scan, a computer operated by the associate can communicate with an exemplary remote server or with an exemplary local computer and associated storage device and receive authority to edit or amend the purchase transaction associated with the receipt. For example, the store can maintain an electronic sales receipt on the server, and upon scanning the paper ticket receipt, the associate authenticates that she or he is performing actions for the particular customer associated with the particular purchase transaction. An electronic sales receipt displayed upon a portable computerized device can perform the same function as the scanned paper ticket receipt. Once a customer has access to an electronic sales receipt, a number of processes are envisioned for the customer to provide the electronic sales receipt or authentication that the customer is authorized to act with regard to the electronic sales receipt. According to one embodiment, permitting a customer service associate to use hardware already available, the customer can display a barcode associated with the electronic sales receipt upon a display of a portable computerized device. If the barcode displayed upon the screen is small, for example, a small portion of an overall display of a receipt including various details of the purchases made upon the receipt, the barcode can be either difficult or impossible for a typical barcode scanner used by an associate to correctly detect the barcode. According to one embodiment, the customer can command the portable computerized device to display the barcode associated with a selected receipt across the entire or substantially across the entire display, thereby making the receipt significantly easier to scan with a barcode scanner. A barcode associated with a particular or unique electronic sales receipt is a displayed indication to the electronic sales receipt. Other embodiments of a displayed indication to an electronic sales receipt can include a number associated with or indicated by the barcode, a generated number sequence identifying a particular receipt or query for a receipt, or any other graphical or textual display that can be used to identify a particular sales receipt to a computer operated by a customer service associate.

According to another embodiment, a customer can be provided a one-time personal identification number (PIN) associated with an electronic sales receipt, and the customer can enter the one time pin at a terminal associated with the computer of the customer service agent to authenticate the customer and the associated receipt. In such an embodiment, the customer can access a record of electronic sales receipts associated with the customer's account and, upon selecting a particular electronic sales receipt, a remote server in communication with the portable computerized device of the customer and a computer of the associate can provide a PIN for the customer to enter into the terminal of the associate's computer. According to another process, the portable computerized device can provide an ability for the customer to establish a data link to the associate's computer, the link, for example, including one of a local wireless network or a Bluetooth® connection, and, upon the customer selecting a particular electronic sales receipt upon the portable computerized device, the device can provide data to the associate's computer identifying and authenticating the selected electronic sales receipt. A number of processes for a customer to provide an electronic sale receipt or information therefrom to a customer service associate are envisioned, and the disclosure is not intended to be limited to the particular exemplary processes disclosed herein.

A return process can be disclosed, for example, with the customer activating a program for returning an item or activating a function within an overall shopping program. When the customer approaches the customer service counter, the customer can select an item for return, for example, by scanning the product to be returned or select the receipt including the item to be returned. Upon activation by the customer, for example, by pressing a button, shaking the device, voice activation, or any other command process known in the art, a barcode, a barcode number, a PIN, or any other indication useful to communicate information to a customer service associate can be displayed upon the display of the device of the customer.

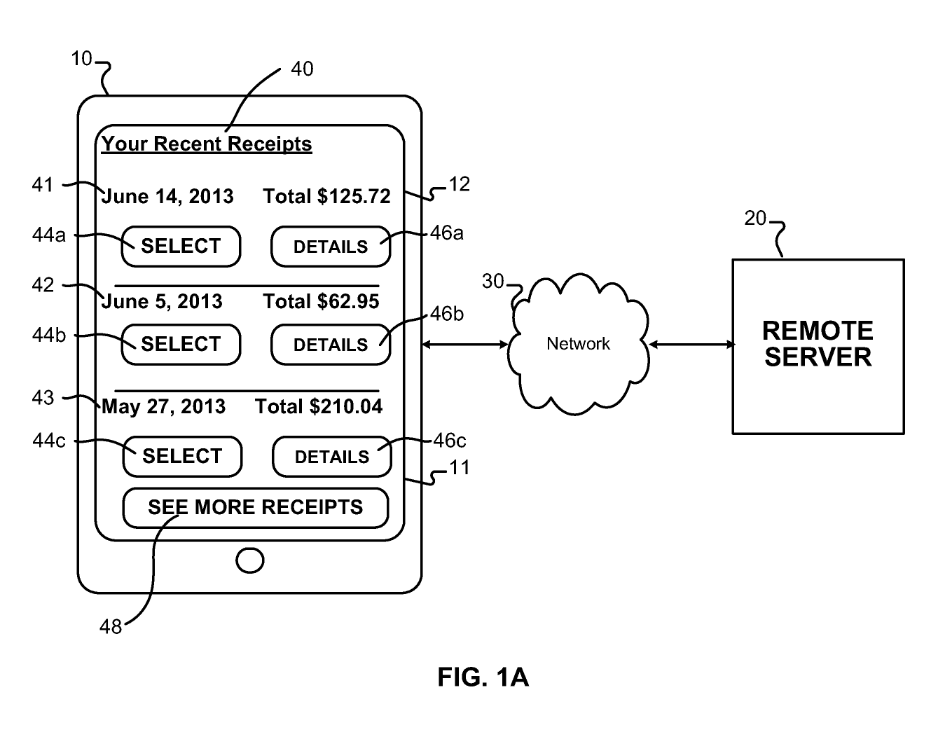

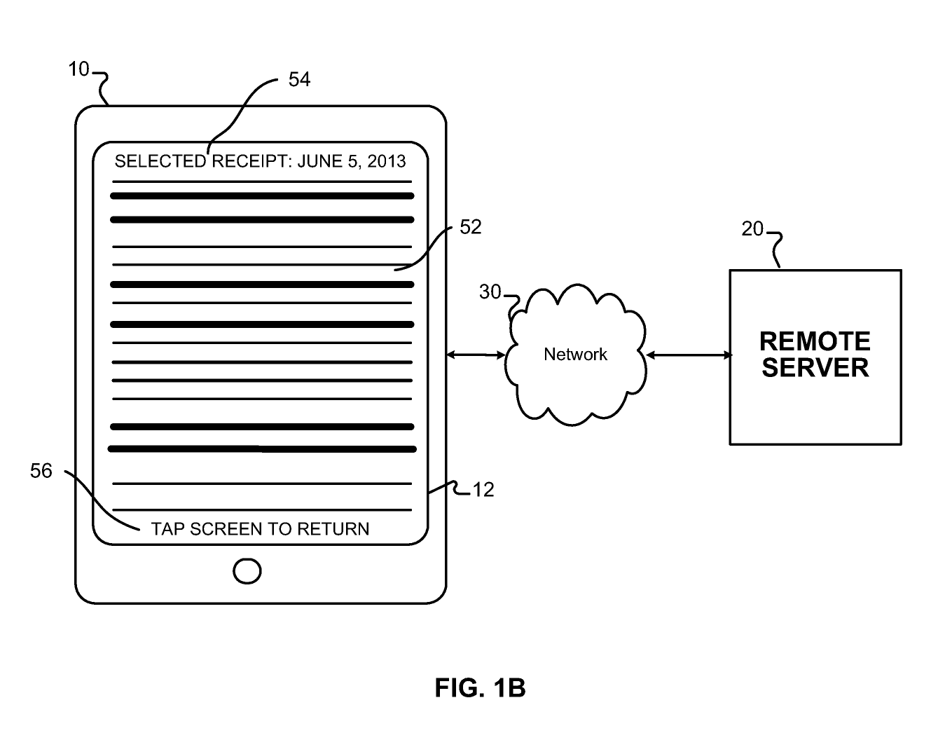

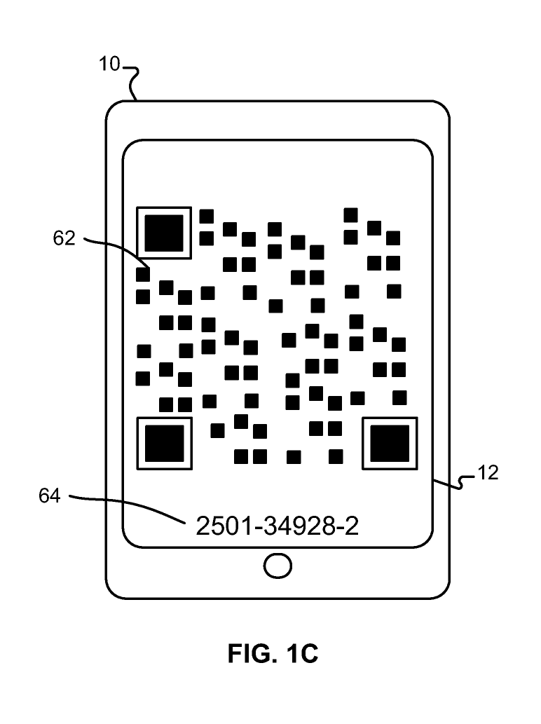

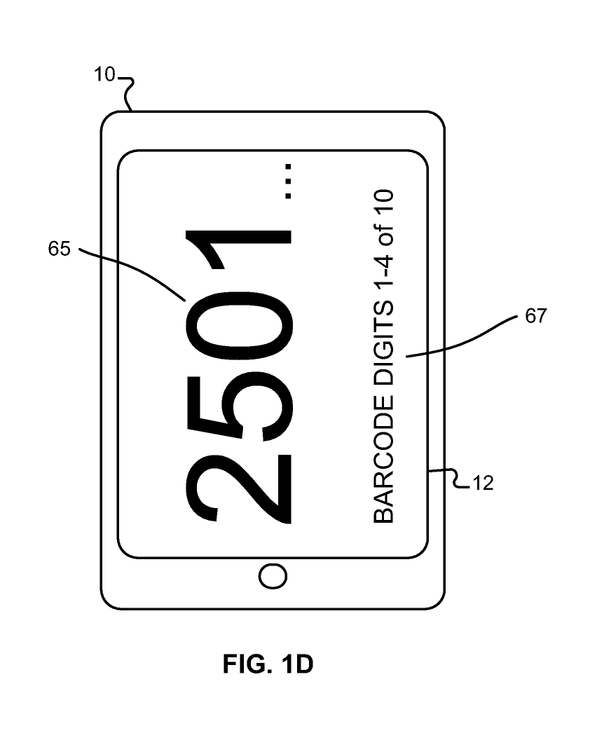

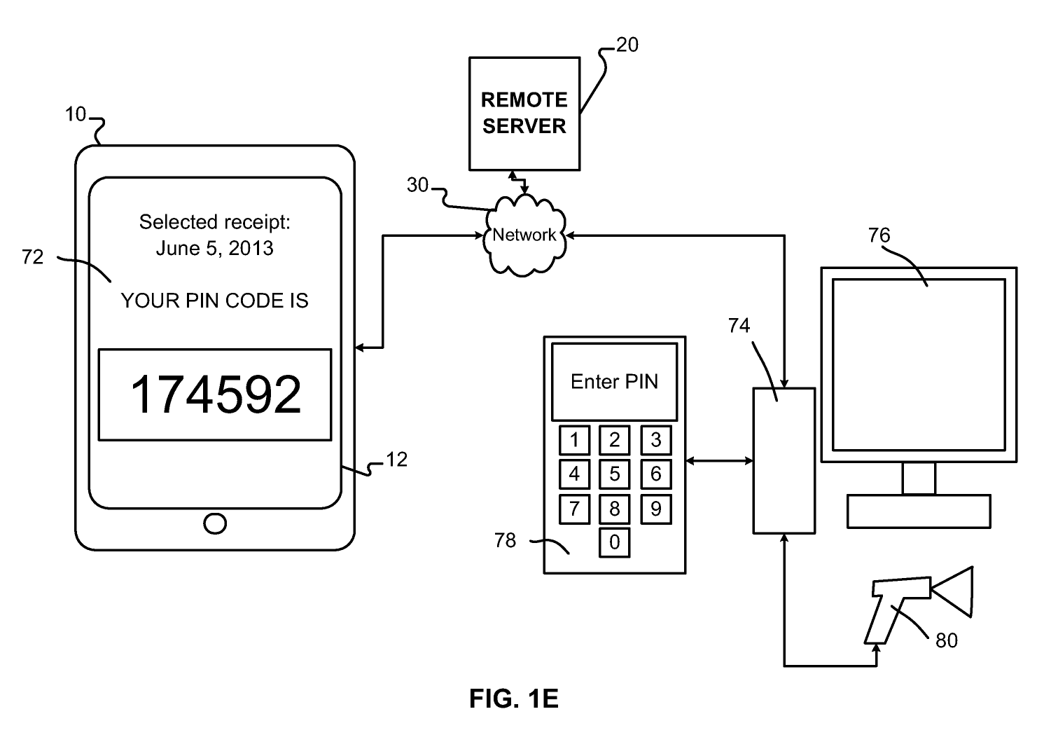

Referring now to FIG. 1A, a portable computerized device 10 in communication with a remote server 20 via a network 30 is illustrated. Portable computerized device 10 is embodied as an exemplary smart-phone. Remote server 20 can be referred to as a customer service server. While one remote server 20 is illustrated, the term “remote server” refers to one or more servers that operate in an individual or distributed manner. Further, as used herein, the term “network” can refer to any communication network including, but not limited to, a wireless network, a cellular network, an intranet, the Internet, or combinations thereof. In the illustrated example, the portable computerized device 10 is displaying a graphical user interface (GUI) 12 on a touch screen 11 of the portable computerized device 10. While a touch screen 11 is illustrated, it should be appreciated that other user interfaces can be used to allow a user to interact with the portable computerized device 10.

In one embodiment, the GUI 12 allows a user to activate software to query a remote server for historical electronic sales receipts. The GUI 12 can display a banner 40 indicating to the consumer/customer that recent sales receipts have been identified and are currently being displayed upon GUI 12. A plurality of recent receipts 41, 42, and 43 are summarized by purchase date and order total. Buttons 46a, 46b, and 46c are provided, respective to receipts 41, 42, and 43, to permit the customer to request details on any of the receipts, for example, to permit the customer to find a particular desired receipt. In another embodiment, a search function can be provided, for example, permitting a customer to look for a particular product that the customer is trying to return, with the search function identifying a particular receipt corresponding to a recent purchase of the particular product. In one embodiment, a search for a particular product on past receipts of the customer can be prompted by scanning a barcode of the item with a camera device upon the computerized device of the customer. Buttons 44a, 44b, and 44c are provided, respective to receipts 41, 42, and 43, to permit the customer to select any of the receipts as the receipt to retrieved from the server. In the event the desired receipt is not shown upon the screen, a button 48 is provided permitting the customer to search through additional receipts.

FIG. 1B illustrates an exemplary portable computerized device providing a barcode associated with a selected electronic sales receipt. GUI 12 is illustrated displaying information related to a selected electronic sales receipt. Banner 54 announces or confirms to the customer which electronic sales receipt has been retrieved from the remote server 20 over network 30. Barcode 52 is illustrated, with the barcode being displayed across a majority of the display. In another embodiment, all text can be omitted from the display, and the barcode can be displayed across the entire display. Message 56 instructs the customer to tap the screen when the customer wishes to exit the barcode display function.

Barcodes are available in a plurality of formats, including three dimensional barcodes and quick response codes or QR codes. FIG. 1C illustrates an exemplary portable computerized device providing an alternative embodiment of a barcode associated with a selected electronic sales receipt. GUI 12 is illustrated displaying information related to a selected electronic sales receipt. A barcode 62 embodied as a QR code is illustrated, with the barcode being displayed across a majority of the display. A number 64 associated with the barcode is illustrated for manual entry, if desired, by the customer service associate. According to one embodiment, the number 64 can be color coded for easy identification by the associate.

FIG. 1D illustrates a segment of a barcode number associated with a selected electronic sales receipt displayed upon the portable computerized device. A customer service associate can manually enter a barcode number. In order to aid the associate in seeing numbers displayed on a small device held by the customer, the display can be configured to display a few digits of the barcode number at a time. The customer can cycle through the numbers by tapping the screen, pressing a button, shaking the device, using a voice command or any other command process known in the art. If the customer wishes to go backwards and show earlier digits, the customer can swipe a finger from right to left in the display, use a voice command, or any other command process known in the art. Digits 65 are illustrated on GUI 12 of device 10, along with message 67 providing context for the displayed digits.

FIG. 1E illustrates an exemplary portable computerized device providing personal identification number associated with a selected electronic sales receipt, wherein the number can be used to authenticate the customer and the selected electronic sales receipt to a customer service associate. GUI 12 is illustrated displaying information related to a selected electronic sales receipt. Message 72 displays a PIN provided by remote server 20 over network 30, wherein the PIN is uniquely associated with a selected electronic sales receipt stored upon the remote server. In order for the PIN number to be provided, the customer may have had to provide authentication information to confirm the identity of the customer. Remote server 20 is further in communication with store computer 74 over network 30. Computer 74 includes display 76 and is in communication with terminal 78, whereby a customer can enter information such as a PIN. Remote server 20 can provide the correct PIN and information associated with the selected electronic sales receipt to computer 74, such that when a correct PIN number is entered into terminal 78, computer 74 can be authorized to execute transactions related to the selected electronic sales receipt, such a performing returns or product exchanges. Display 76 can further display information about the electronic sales receipt and/or information about the desired transaction, for example, providing store policies governing the return/exchange transaction desired by the customer. Barcode scanner device 80 is illustrated for use in other processes disclosed herein, for example, scanning the barcodes provided on FIG. 1B or 1C. Device 80 can include a device known in the art including a laser scanner and sensor device, registering a response as laser light is scanned over a barcode. In another embodiment, device 80 can include a camera device used to capture an image or images of a barcode, and the images can be analyzed through image recognition software to identify information related to the barcode.

The computer 74 operated by the customer service associate is provided as a non-limiting example of a computerized device that can be utilized by the associate. In another embodiment, the associate could use a portable computerized device with a camera device capable of capturing an image displayed upon the display of the portable computerized device of the customer.

A benefit of the processes disclosed herein is that authenticated information can be passed from the customer to the customer service associate without the associate ever having to touch the device owned by the customer.

The examples of FIGS. 1A-1D are provided for example only and not intended to be limiting. It should be appreciated that variations of the GUI are contemplated and are within the scope of the disclosure. Furthermore, while a portable computerized device embodied as a smart phone is illustrated, it will be appreciated that any number of tablet computers or other similar portable computerized devices can be utilized according to the processes disclosed herein.

The processes disclosed discuss a remote server storing and accessing electronic sales receipts based upon a demand from a customer. In an alternative embodiment, the electronic sales receipts can be stored upon the portable computerized device of the shopper. In one embodiment, a remote server can email or otherwise send the electronic sales receipt to the customer's device. In another embodiment, the customer can use a camera device located upon the portable computerized device to take an image of a barcode of a paper ticket receipt, and based upon image recognition software, the barcode or other information can be stored upon the device.

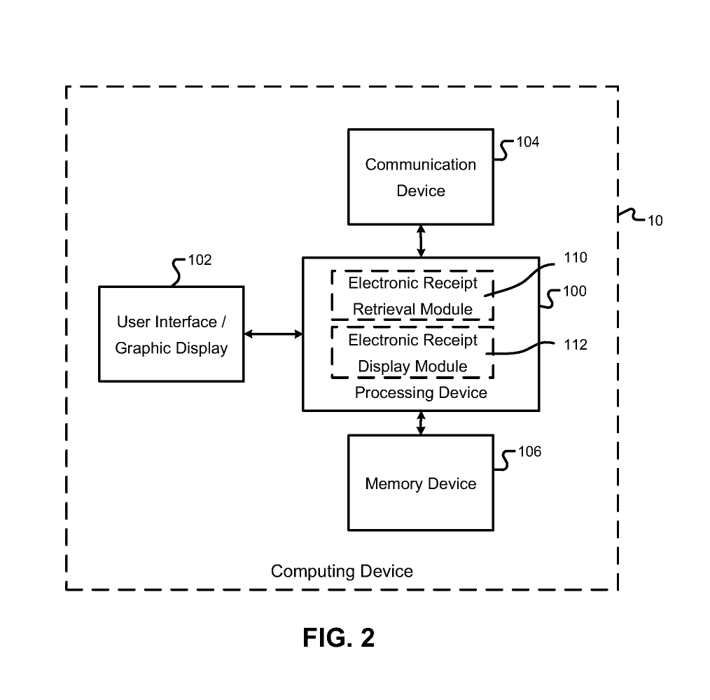

Referring now to FIG. 2, a block diagram illustrates exemplary components of a portable computerized device configured to operate according to the processes disclosed herein. Portable computerized device 10 includes a processing device 100, a user interface 102, a communication device 104, and a memory device 106.

The processing device 100 can include memory, e.g., read only memory (ROM) and random access memory (RAM), storing processor-executable instructions and one or more processors that execute the processor-executable instructions. In embodiments where the processing device 100 includes two or more processors, the processors can operate in a parallel or distributed manner. The processing device 100 can execute the operating system of the portable computerized device. In the illustrative embodiment, the processing device 100 also executes electronic receipt retrieval module 110 and electronic receipt display module 112, which are described in greater detail below.

The user interface 102 is a device that allows a user to interact with the portable computerized device 10. While one user interface 102 is shown, the term “user interface” can include, but is not limited to, a touch screen, a physical keyboard, a mouse, a microphone, and/or a speaker. The communication device 104 is a device that allows the portable computerized device 10 to communicate with another device, e.g., the remote server 20, via the network 30. The communication device 104 can include one or more wireless transceivers for performing wireless communication and/or one or more communication ports for performing wired communication. The memory device 106 is a device that stores data generated or received by the portable computerized device 10. The memory device 106 can include, but is not limited to a hard disc drive, an optical disc drive, and/or a flash memory drive.

In some embodiments, the electronic receipt retrieval module 110 is embodied as processor-executable instructions stored in the memory of the processing device 100. The processing device 100 can execute electronic receipt retrieval module 110. The electronic receipt retrieval module 110 can be preloaded into the operating system of the portable computerized device 10, can be downloaded from a third party server by a user of the portable computerized device 10, or can be generated on the portable computerized device 10.

The electronic receipt retrieval module 110 provides an exemplary interface for the customer to request access to stored electronic sales receipts from a remote server 20. Module 110 can provide the customer with information from the remote server 20, for example, a query from the server for the customer to provide authentication information to confirm an identity of the customer, a list of recent receipts associated with the customer's account, or details regarding any of the available receipts. The electronic receipt retrieval module 110 may be configured to perform additional functions without departing from the scope of this disclosure.

The electronic receipt display module 112 receives information about a particular receipt, for example, a number associated with a barcode, and renders a representative barcode upon a display, for example, the user interface 102 of the device. Electronic receipt display module 112 can include adjustable parameters, for example, controlling how much of the display is used to display a barcode and whether or not text is displayed with the barcode.

Embodiments in accordance with the present disclosure may be embodied as an device, process, or computer program product. Accordingly, the present disclosure may take the form of an entirely hardware embodiment, an entirely software embodiment (including firmware, resident software, micro-code, etc.), or an embodiment combining software and hardware aspects that may all generally be referred to herein as a “module” or “system.” Furthermore, the present disclosure may take the form of a computer program product embodied in any tangible medium of expression having computer-usable program code embodied in the medium.

Any combination of one or more computer-usable or computer-readable media may be utilized. For example, a computer-readable medium may include one or more of a portable computer diskette, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device. Computer program code for carrying out operations of the present disclosure may be written in any combination of one or more programming languages.

Embodiments may also be implemented in cloud computing environments. In this description and the following claims, “cloud computing” may be defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.)

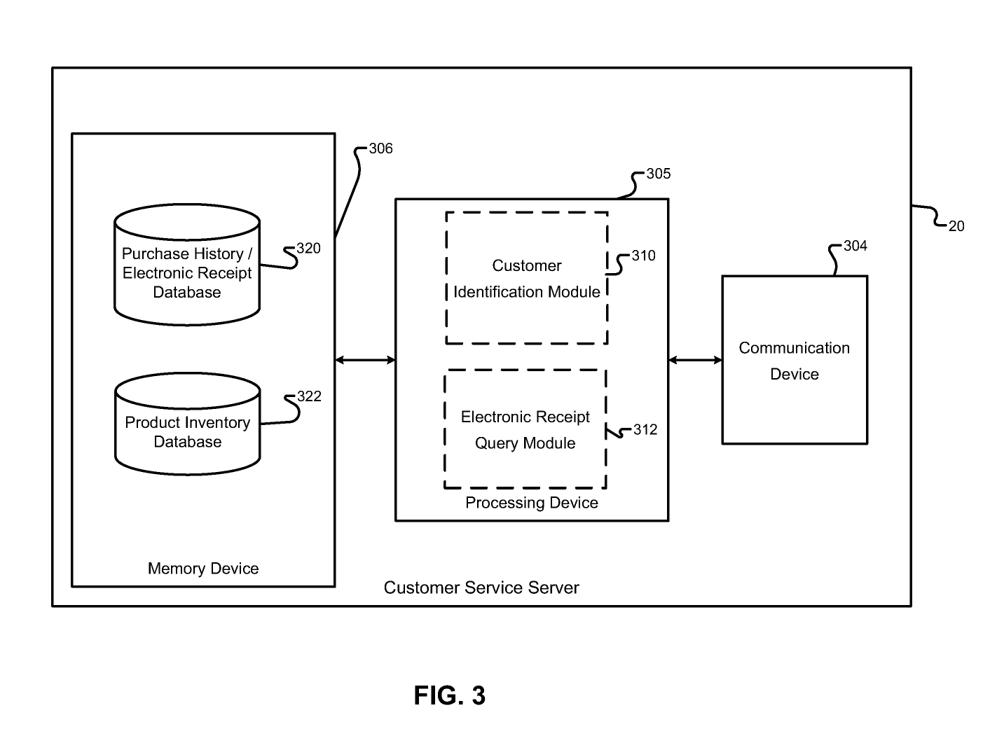

Referring now to FIG. 3, a block diagram illustrating an exemplary remote server 20 is depicted. In an exemplary embodiment, the remote server 20 embodied as a customer service server includes a processing device 305, a communication device 304, and memory device 306.

The processing device 305 can include memory, e.g., read only memory (ROM) and random access memory (RAM), storing processor-executable instructions and one or more processors that execute the processor-executable instructions. In embodiments where the processing device 305 includes two or more processors, the processors can operate in a parallel or distributed manner. In the illustrative embodiment, the processing device 305 executes an electronic receipt query module 312 and a customer identification module 310, which are described in greater detail below.

The communication device 304 is a device that allows the remote server 20 to communicate with another device, e.g., a portable computerized device, via the network 30. The communication device 304 can include one or more wireless transceivers for performing wireless communication and/or one or more communication ports for performing wired communication.

The memory device 306 is a device that stores data generated or received by the remote server 20. The memory device 306 can include, but is not limited to a hard disc drive, an optical disc drive, and/or a flash memory drive. The memory device 306 is accessible to the processing device 305. A purchase history/electronic receipt database 320 can be stored in the memory device 306. Database 320 can include information related to a plurality of customer accounts, and a plurality of sales receipts can be stored related to each customer account. Details regarding the customer accounts such as login/identity authentication information can be stored in database 320 or can be stored in a separate customer accounts database. A product inventory database 322 can also be stored in the memory device, for example, providing a list of products offered at a particular store, prices for products in the store, return and exchange policies for particular items in the store, etc.

The customer identification module 310 can query and receive information from a customer's portable computerized device to authenticate the identity of the customer using the device. Data received from the customer can be compared with information from memory device 306, and module 310 can either confirm or deny authentication of the identity of the customer based upon the comparing.

The electronic receipt query module 312 receives customer account information from customer identification module 310. Based upon the customer account information, module 312 can access a plurality of receipts associated with the account, provide details about the receipts to the device of the customer, process inquiries by the customer about particular receipts, search through receipts for a desired item, and designate a particular electronic sales receipt as selected based upon input from the customer. In one embodiment, module 312 can include programming to provide information to a computer operated by a customer service associate and authorize the computer to perform transactions related to the selected receipt. In another embodiment, the customer service computer can be in communication with a separate server providing customer service functions such as authorizing particular transactions related to an identified sales receipt.

It is appreciated that the foregoing example of the remote server 20 is not intended to be limiting. Variations of the exemplary remote server 20 are contemplated and within the scope of the disclosure.

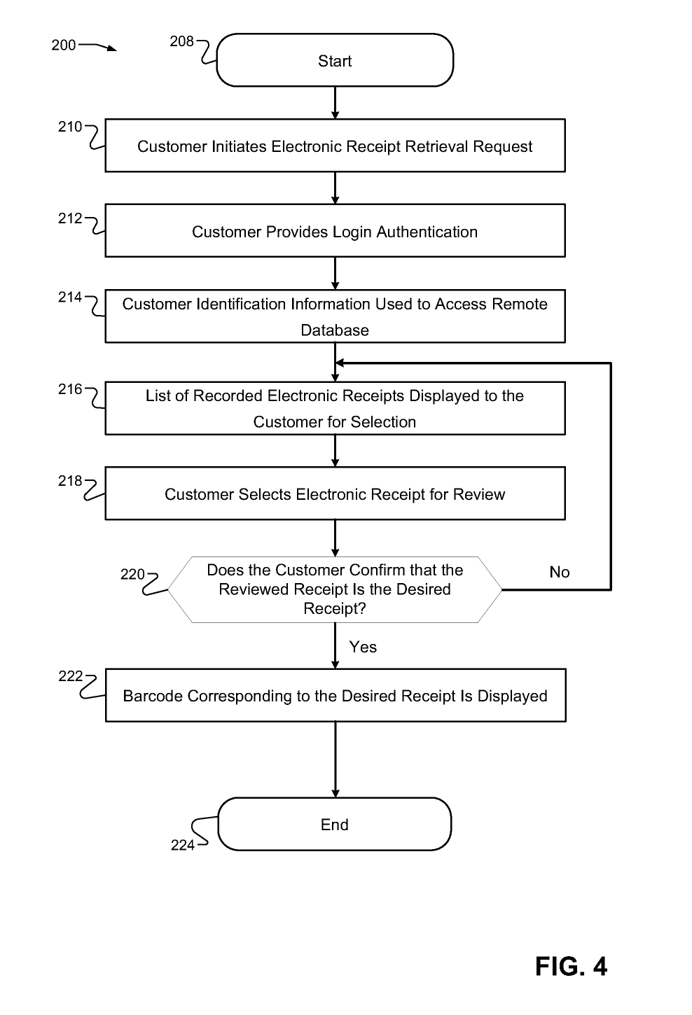

Referring now to FIG. 4, an exemplary process 200 is illustrated for using electronic sales receipts based upon a customer query entered through a portable computerized device. Process 200 starts at step 208. At step 210, the customer initiates an electronic receipt retrieval request, wherein an exemplary remote server is notified that a customer wishes to retrieve a stored electronic sales receipt. At step 212, the customer is prompted to provide login information to authenticate an identity of the customer. At step 214, the information provided by the customer is used to access a remote database, for example, including a stored electronic sales receipt or a plurality of stored electronic sales receipts. At step 216, a list of recorded or stored electronic sales receipts are displayed to the customer, and at step 218 the customer can review one of the receipts. If the customer confirms that the reviewed receipt is the desired receipt required for use in a current transaction at step 220, then the process proceeds to step 222. If the customer does not confirm that the reviewed receipt is the desired receipt, then the process returns to step 216, whereat the customer may review other receipts. At step 222, a barcode associated with the desired or selected receipt is displayed upon a display of the customer's device. The displayed barcode can be utilized by a customer service associate according to processes disclosed herein. At step 224, the process ends.

The flowchart and block diagrams in the flow diagrams illustrate the architecture, functionality, and operation of possible implementations of systems, processes, and computer program products according to various embodiments of the present disclosure. In this regard, each block in the flowchart or block diagrams may represent a module, segment, or portion of code, which comprises one or more executable instructions for implementing the specified logical function(s). It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions. These computer program instructions may also be stored in a computer-readable medium that can direct a computer or other programmable data processing device to function in a particular manner, such that the instructions stored in the computer-readable medium produce an article of manufacture including instruction means which implement the function/act specified in the flowchart and/or block diagram block or blocks.

The above description of illustrated examples of the present disclosure, including what is described in the Abstract, are not intended to be exhaustive or to be limitation to the precise forms disclosed. While specific embodiments of, and examples for, the disclosure are described herein for illustrative purposes, various equivalent modifications are possible without departing from the broader spirit and scope of the present disclosure. Indeed, it is appreciated that the specific example voltages, currents, frequencies, power range values, times, etc., are provided for explanation purposes and that other values may also be employed in other embodiments and examples in accordance with the teachings of the present disclosure.

What is claimed is:

1. A computer-implemented process permitting a customer to access a stored electronic sales receipt and provide information from the electronic sales receipt to a customer service associate, the process comprising:
in a computerized device operated by the customer,
accessing the stored electronic sales receipt, and
generating a displayed indication to the electronic sales receipt; and
in a computerized device operated by the customer service associate,
receiving the displayed indication, and
processing a transaction related to the electronic sales receipt based upon the displayed indication.

2. The computer-implemented process of claim 1, wherein generating the displayed indication comprises displaying a barcode upon the computerized device operated by the customer.

3. The computer-implemented process of claim 2, wherein displaying the barcode comprises displaying the barcode across an entire display of the computerized device operated by the customer.

4. The computer-implemented process of claim 2, wherein receiving the displayed indication comprises utilizing a barcode scanner to scan the displayed barcode.

5. The computer-implemented process of claim 2, wherein generating the displayed indication further comprises displaying a number associated with the barcode.

6. The computer-implemented process of claim 2, wherein displaying the barcode comprises displaying a QR code.

7. The computer-implemented process of claim 6, wherein receiving the displayed indication comprises capturing an image of the displayed QR code.

8. The computer-implemented process of claim 1, wherein generating the displayed indication comprises displaying a barcode number associated with the electronic sales receipt.

9. The computer-implemented process of claim 1, wherein generating the displayed indication comprises displaying a personal identification number generated by a remote server device and associated with the electronic sales receipt.

10. The computer-implemented process of claim 9, wherein receiving the displayed indication comprises monitoring entry of the personal identification number upon a terminal associated with the computerized device operated by the customer service associate.

11. The computer-implemented process of claim 1, further comprising displaying a plurality of stored electronic sales receipts for selection to the customer; and
wherein accessing the stored electronic sales receipt comprises:
monitoring selection of a desired electronic sales receipt from the plurality of stored electronic sales receipts; and
retrieving details for the desired electronic sales receipt from a remote server device.

12. The computer-implemented process of claim 1, further comprising:
authenticating, with the portable computerized device operated by the customer, the identity of the customer.

13. The computer-implemented process of claim 1, wherein processing the transaction comprises one of returning and exchanging an item listed upon the electronic sales receipt.

14. The computer-implemented process of claim 1, wherein accessing the electronic sales receipt comprises:
identifying a plurality of electronic sales receipts associated with the customer;
searching for a particular desired item within the plurality of electronic sales receipts; and
accessing one of the electronic sales receipts based upon the searching.

15. The computer-implemented process of claim 1, wherein accessing the electronic sales receipt comprises locating the electronic sales receipt upon a memory device of the computerized device operated by the customer.

16. A computerized application operable upon a computerized device permitting a customer to access a stored electronic sales receipt, the application configured to:
in the computerized device,
request from a remote server device access to a stored electronic sales receipt;
provide authentication information to the remote server device identifying the identity of the customer;
receive information about the electronic sales receipt; and
display a barcode associated with the electronic sales receipt.

17. The computerized application of claim 16, wherein the application configured to display the barcode is configured to display the barcode across an entire display of the computerized device.

18. The computerized application of claim 16, wherein the application configured to request from access to the stored electronic sales receipt comprises the application being configured to scan an item to be returned and the application being configured to request from the remote server that a search be executed to find the stored electronic sales receipt including the item to be returned.

19. A computerized customer service server having a processing device and permitting a customer to access a stored electronic sales receipt, the customer service server comprising:
a customer identification module receiving information confirming an identity of the customer;
an electronic receipt query module:
accessing an electronic sales receipt associated with a registered account associated with the customer; and
providing information from the electronic sales receipt to a portable computerized device operated by the customer, wherein the information includes data related to a barcode that can be displayed upon the portable computerized device.

20. The computerized server of claim 19, wherein the electronic receipt query module further authorizes a computer operated by a customer service associate to process a transaction related to the electronic sales receipt based upon the computer scanning the barcode upon the portable computerized device.
